(19) United States
(12) Patent Application Publication
(10) Pub. No.: US 2023/0220512 A1
(43) Pub. Date: Jul. 13, 2023

(54) INDUCTION HARDENING SYSTEM AND INDUCTION HARDENING METHOD

(71) Applicant: AKTIEBOLAGET SKF, Goteborg (SE)

(72) Inventors: Fred MENIG, Sulzthal (DE); Martina STICHT, Sennfeld (DE); Gerhard WAGNER, Prichsenstadt (DE); Michael WENDEL, Bremen (DE)

(21) Appl. No.: 18/091,480

(22) Filed: Dec. 30, 2022

(30) Foreign Application Priority Data
Jan. 13, 2022 (DE) 102022200324.1

(51) Int. Cl. C21D 11/00; H05B 6/06; H05B 6/10; C21D 1/18; C21D 1/42

(52) U.S. Cl. CPC C21D 11/00; H05B 6/06; H05B 6/102; C21D 1/18; C21D 1/42; C21D 6/002

(57) ABSTRACT

An inductive hardening system for hardening a component includes a holding unit for holding the component, an induction coil configured to induce an electrical current in the component to heat the component, and a control unit configured to control the induction coil to produce a first amount of heat per unit area in the component until a predetermined temperature is reached and/or a predetermined time is elapsed and after the predetermined temperature is reached and/or the predetermined time is elapsed, to control the induction coil to produce a second amount of heat per unit area in the component, the second amount of heat being from 3% to 80% of the first amount of heat.

### CROSS-REFERENCE

This application claims priority to German patent application no. 10 2022 200 324.1 filed on Jan. 13, 2022, the contents of which are fully incorporated herein by reference.

### TECHNOLOGICAL FIELD

The present disclosure is directed to an inductive hardening system for hardening a component which system is configured to carry out the inductive hardening at a first temperature and then at a second, lower temperature, as well as to a related inductive hardening method.

### BACKGROUND

In order to harden a component, the component must be heated in the area to be hardened above what is known as the austenitization start temperature (As temperature), from which point a phase transition from ferrite to austenite takes place. Various methods can be used here. Among others, thermal methods are used in which the microstructure of the steel is changed by a heat treatment so that the component has an increased hardness at least in partial regions. One of these hardening methods is inductive hardening in which a current-carrying coil is brought to the component at a certain distance (coupling distance) so that a current is induced in the component that leads to a heating of the component. Here the induction coil can completely or partially surround the component, and/or, in particular for large-surface applications, be moved relative to the component so that the entire component or a partial region of the component is hardened.

In order to achieve such an increased hardness, the component must be heated in the region to be hardened above the so-called austenitization start temperature (As temperature) starting from which a phase transition from ferrite to austenite occurs. Depending on the steel composition, microstructural condition, and/or heating speed, this temperature can fall in the range between 700° C. and 1100° C. After the heating, the component or the region to be hardened is brought as quickly as possible to a temperature below the martensite start temperature (Ms temperature), starting from which the formed austenite transforms into martensite. This temperature can fall between 500° C. and 100° C., and is also dependent on the steel composition, the austenitization conditions and the microstructural condition.

In order to form a particularly uniformly hardened layer during this transformation process, it is necessary to minimize temperature inconsistencies in the component before it cools down to the martensite temperature so that a uniform-as-possible transition occurs from ferrite to austenite and from austenite to martensite.

### SUMMARY

An aspect of the present disclosure is therefore to provide an inductive hardening system or an inductive hardening method with which the temperature inconsistencies in a component to be inductively hardened can be avoided.

In the following, an inductive hardening system for hardening a component, as well as an inductive hardening method, is presented. Here the hardening method can be performed with the inductive hardening system or with any other inductive hardening systems. In particular, the method is suited to control the processes running in a control unit controlling an inductive hardening system.

The disclosed inductive hardening system comprises, as usual, at least one retaining unit for holding the component and at least one induction coil for heating the component, in which the induction coil is designed to induce an electric current in the component and thus to achieve a defined heat input in the component in order to heat it. Here the hardening system furthermore includes a control unit that is configured to control the heat input into the component as a function of a predetermined temperature reached and/or a predetermined time reached so that up to the reaching of the predetermined temperature and/or the reaching of the predetermined time a first heat input is introduced into the component. After reaching the predetermined temperature and/or the predetermined time, the control unit is furthermore configured to reduce the heat input into the component to preferably 3% to 80% of the first heat input so that a second, reduced heat input is introduced into the component.

Here the first heat input can be chosen such that it is a maximum heat input. Here it is to be noted that the maximum heat input is not the technically maximum heat input that would be theoretically achievable with the hardening system but rather the heat input that is defined by an operator during the setting of the hardening parameters as the maximum heat input for the specific component to be hardened.

The predetermined temperature can be determined in particular on the surface of the component in the region of the region to be hardened. The temperature is preferably determined in the center of the region to be hardened and directly after the influence of the induction coil.

The corresponding inductive hardening method of a component using an induction coil that induces an electrical current in the component and thus achieves a definable heat input in the component and thereby heats it thus comprises the steps:
introducing a first heat input into the component as a function of a predetermined temperature reached and/or a predetermined time reached so that up to the reaching of the predetermined temperature and/or predetermined time the first heat input is introduced into the component; and
reducing the heat input into the component after the reaching of the predetermined temperature and/or the predetermined time to preferably 3 to 80% of the first heat input.

According to a further preferred exemplary embodiment, the at least one induction coil is energizable by an alternating current source, in particular a generator with alternating current of predeterminable magnitude. Furthermore, the control unit is configured to control the AC source in order to adjust the current strength and/or the voltage and/or the frequency of the alternating current such that a first heat input or a second reduced heat input is introduced into the component.

Analogously, a preferred exemplary embodiment of the method furthermore includes the step:
adjusting a current strength, voltage, and/or a frequency of an alternating current with which the induction coil is energized such that a first heat input or a second, reduced heat input is introduced into the component.

According to a further advantageous exemplary embodiment, the hardening system includes at least one induction coil holder with which the at least one induction coil is holdable in a predeterminable coupling distance to the component. Furthermore, the control unit is configured to control the induction coil holder in order to adjust the coupling distance for a first heat input or a second, reduced heat input.

Accordingly, an exemplary embodiment of the method includes the step:
adjusting a coupling distance of the induction coil to the component, in particular by controlling an induction-coil holder, in order to introduce a first heat input or a second, reduced heat input.

Here the coupling distance is preferably increased for the second, reduced heat input.

Furthermore, a hardening system is advantageous in which the induction coil is configured to at least partially cover the component, the induction coil and the component being movable relative to each other. For this purpose, for example, the induction coil can be moved over the stationary component, or the induction coil can be stationary and the component is moved along the induction coil. Of course it is naturally also possible to move both the component and the induction coil. Furthermore, the control unit is configured to control a relative speed of the induction coil and the component.

The method can advantageously thus also include the step: moving the induction coil relative to the component so that a predetermined relative speed is set.

Here it is advantageous in particular that the control unit is furthermore configured to control the relative speed of the induction coil and the component such that up to the reaching of a predetermined temperature and/or a predetermined time, a first relative speed arises between component and induction coil, and after reaching a predetermined temperature and/or a predetermined time, a second relative speed arises between component and induction coil, wherein the second relative speed is greater than the first relative speed.

Analogously in the claimed method the following steps are advantageous:
moving the component and/or the induction coil with a first relative speed up to the reaching of a predetermined temperature and/or of a predetermined time; and
increasing the first relative speed to a second relative speed upon reaching the predetermined temperature and/or the predetermined time.

According to a further advantageous exemplary embodiment of the hardening system and method, the first relative speed is determined such that a first heat input is introduced into the component, and the second relative speed is determined such that a second, reduced heat input is introduced into the component.

In the case of stationary induction coils and a rotating component, a rotational speed of the component is adjusted such that it at least satisfies or is greater than the following:

Rotational speedₘᵢₙ (rpm)=30*(1−C_{coverage inductor-workpiece}),

with C=coverage of the tool with respect to the workpiece in percent (0 to 1).

All above-described possibilities to adjust the heat input can be performed alone or in combination. Depending on the component, various measures can also be used. The adjustment of the coupling distance and the adjustment of the energization can also be used on systems or during the hardening of components in which the induction coil completely surrounds the component.

Due to the reduction, but not the complete ending, of the heat input prior to the cooling down to the martensite temperature, a uniform-as-possible temperature distribution is achieved in the component in the circumferential direction. Due to the constant, although reduced, heat input, temperature inconsistencies can be compensated for more quickly than by a complete shutdown and subsequent rest time since not only the component alone must be monitored for the temperature compensation, but rather this process is actively supported.

Overall, by varying the heat input, it is possible to avoid/reduce undesirable structural components after quenching. In addition, a residual stress distribution conducive to the service life is optimized. Due to the variation in the heat input, a deeper formation of the hardened zone is also possible as well as a more uniform distribution of the quench hardness achieved. Due to the variation of the heat input, a particularly good temperature equalization occurs before the quenching; therefore, an improved tension distribution is also achieved during the quenching process, which reduces the risk of crack formation. A reduced component warpage is also thereby achieved.

As components, all metallic components can be hardened; however the disclosure is advantageous in particular for rolling-element bearings, rings, gears, rollers, journals, bushes, and/or disks, i.e., components having a continuous curve. Such components are preferably manufactured from rolling-element bearing steel. Rolling-element steel can comprise, for example, a chemical composition made of carbon (0.43-1.10 mass-%), silicon (0.15-0.35 mass-%), manganese (0.60-1.10 mass-%), chromium (0.30-2.00 mass-%) and molybdenum (0.15-0.75 mass-%). Furthermore, the material of the component can be a material produced or smelted by electro-slag remelting or vacuum arc remelting.

Due to their size (diameter from 100 mm to over 5,500 mm), the above-mentioned components are preferably hardened with a progressive hardening method in which there is a relative movement between the component and the induction coil. Here in particular a so-called pulse hardening is particularly preferred in which the induction coil is not moved only once over the circumference of the component but rather either the coil or the component rotates and repeatedly covers the component. A position on the component thereby experiences a pulsed heat input. Especially with progressive hardening or pulse hardening, due to the relative movement between the component and the coil the component is always heated only locally and cools down after the induction coil or the component has been moved away from a given location.

Especially with progressive hardening or pulse hardening, greater temperature differences thereby arise, in particular in the circumferential direction, that prior to the quenching should be set as low as possible, preferably below 40° C., even better below 20° C., distributed over the component. The above-discussed variation of the heat input delivers particularly good results here, with temperature variations prior to the quenching that preferably lie below 20° C. in the circumferential direction over the component.

According to a further advantageous exemplary embodiment, during the entire hardening process the variation of the heat input can change alternately between a first heat input and a second, reduced heat input. A step-wise heating of the component is thereby achieved in which it is alternated between first heat inputs and second, reduced heat inputs so that already in the process of the hardening a temperature compensation in the component is repeatedly made possible. A controlling of the corresponding hardening system or a corresponding process step ensures in particular a particularly great hardening depth since the component is given the opportunity for heat to penetrate into deeper layers. At the same time, temperature inconsistencies are thereby particularly well avoided, since relative-movement-dependent and frequency-dependent heat-input maximizations can be avoided. This means that with certain settings it can be possible that over the entire hardening time the coil always locally heats a certain point while an adjacent point remains free of heating. Due to the variation of the heat input, such as, for example, by changing the relative-movement speed, such randomly occurring phenomena can be reliably prevented.

According to a further advantageous exemplary embodiment, the predetermined temperature is the austenitization start temperature, the austenitization end temperature, or a temperature in the region between the austenitization start temperature and the austenitization end temperature. The more uniform distribution of the temperature and residual stresses in the circumferential direction achieved by the reduced heat input leads to a reduced warpage after the hardening as well as after the subsequent manufacturing processes. This applies above all in the temperature range between the austenitization start temperature and the austenitization end temperature in which a uniform-as-possible temperature distribution is conducive to a low component warpage. In addition, an equalization of the temperature leads to more uniform thermal expansions and thus to less warpage or plasticity during the heating.

Furthermore, it is advantageous when the predetermined time is a predetermined hardening time.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic representation of a preferred exemplary embodiment of an induction hardening system.

FIG. 2 is a schematic representation of heat input zones of the hardening system depicted in FIG. 1.

FIG. 3 is a schematic representation of a varying heat input.

FIG. 4 is a schematic representation of various preferred exemplary embodiments of the hardening method.

FIG. 5 is a schematic representation of a first preferred exemplary embodiment for varying a heat input.

FIG. 6 is a schematic representation of a second preferred exemplary embodiment for varying a heat input.

FIG. 7 is schematic representations of the heat input with a hardening system according to FIG. 1.

### DETAILED DESCRIPTION

In the following, identical or functionally equivalent elements are designated by the same reference numbers.

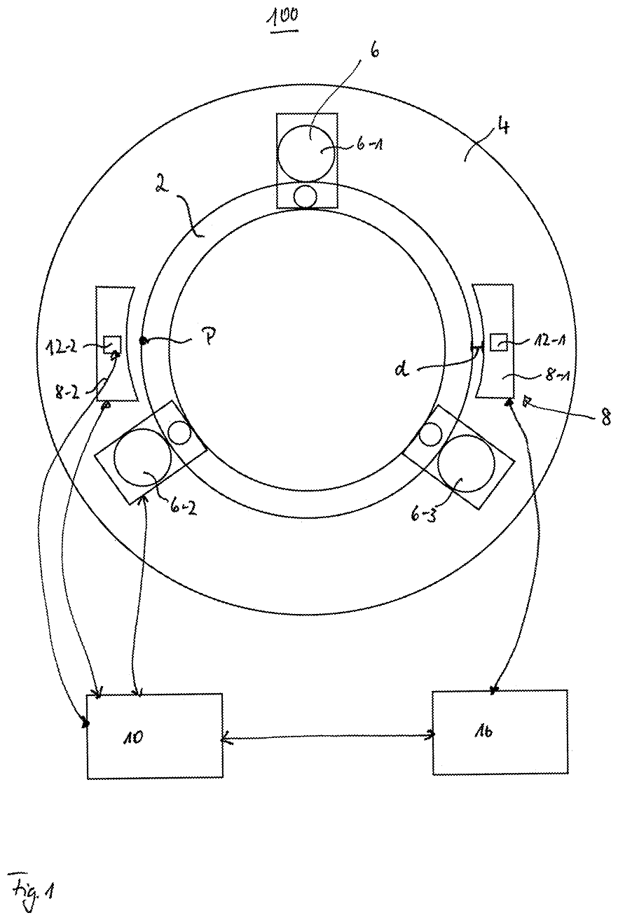

FIG. 1 schematically shows an inductive hardening system 100. With the depicted hardening system 100, a component 2, for example, a bearing ring as depicted here, is supported on a work table 4, and with the aid of drive devices 6 can be traversed along an induction coil 8, in particular can be repeatedly traversed (so-called pulse hardening). Alternatively of course, the induction coil 8 can also be moved along the component 2 with the aid of a drive mechanism 6.

In the depicted exemplary embodiment of the inductive hardening system 100, two coils 8-1 and 8-2 are present that are disposed opposite each other. It is of course also possible to use only one coil or more than two coils.

In the drive mechanism 6 a plurality of drive mechanisms can also be provided, e.g., the drive mechanisms (6-1, 6-2, 6-3); however, more or fewer drive mechanisms can also be present for moving the component 2 (or alternatively the induction coil(s)).

In the exemplary embodiment depicted, the induction coils 8-1; 8-2 are each held by an associated induction coil holder 12-1; 12-2 that ensures that the coil 8 is held at a certain coupling distance d with respect to the workpiece 2. The induction coil 8 itself is furthermore supplied with alternating current by a generator 16 wherein in the depicted exemplary embodiment both coils 8-1, 8-2 can be energized with the same generator 16, but a separate generator can be provided for each coil.

Furthermore, a control unit 10 is provided that controls both induction coils 8, in particular their coupling distance d or their energization (current strength, frequency, voltage) and the drive mechanism 6. Here it is advantageous in particular that the control unit is configured to control the drive mechanism 6 such that a rotational speed of the rotating component is adjustable or controlled. Furthermore, it is possible to use different control units 10 for the coils 8 or the drive mechanism 6 or to provide individual control units in the respective components, in particular in the induction coil 8 and in the drive mechanism 6, which control units act individually on coil 8 or drive mechanism 6. The induction coil holder 12 can also be controlled by the control unit 10 or a separate control unit in order to set the coupling distance d. The control unit 10 can also be configured to control the generator 16 in order to supply the coil 8 with a certain current of certain frequency, voltage, and strength, whereby the control unit can be provided separately or integrally.

It is to be noted that the induction hardening system 100 depicted in FIG. 1 represents only an exemplary embodiment, and other induction hardening systems can also be similarly controlled with the method steps described in the following in order to achieve a uniform-as-possible temperature input. The steps preferred for this purpose are described in the following for an exemplary embodiment in which a single control unit 10 is provided that can control not only two coils 8-1; 8-2, their associated holders 12-1; 12-2, the drive mechanism 6-1; 6-2; 6-3, and the generator 16, but also further parts, not shown here, of the induction assembly 100 in order to achieve a uniform-as-possible temperature distribution.

In order to achieve this, a heat input introduced by the coils 8 into the component 2 during the hardening process is variable, with a first heat input being introduced into the component 2 up to a predetermined time or up to a predetermined temperature reached, and the heat input is preferably maximized in the component 2 with the help of the first heat input, and from reaching the predetermined temperature or the predetermined time, the heat input is reduced. The first, preferably maximized, or second, reduced, heat input can be defined in advance in a manner depending on the properties of the to-be-hardened component 2, and in particular its material properties, the final hardness to be achieved, and/or the hardness penetration depth to be reached.

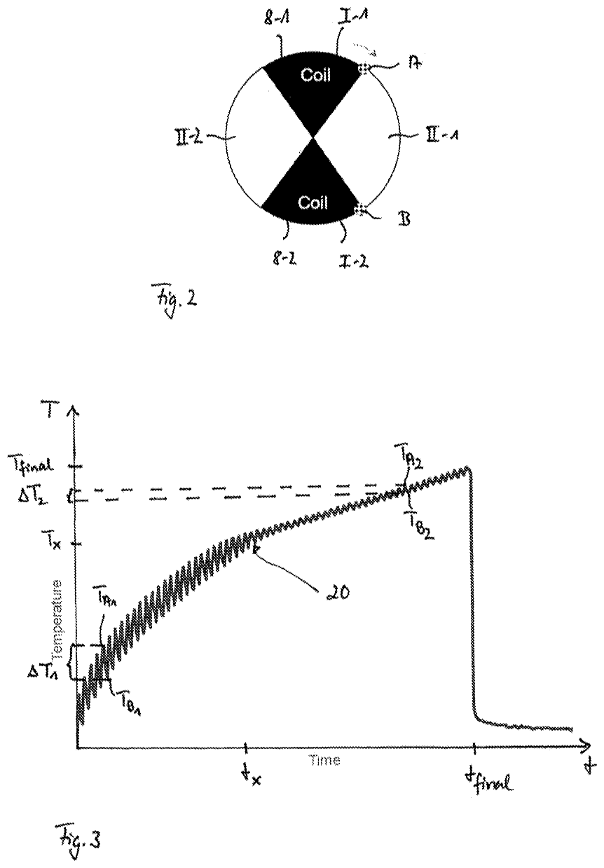

Furthermore in the hardening system 100 depicted in FIG. 1, due to the only partial covering of the component 2 with the induction coils 8-1, 8-2, the component is not heated everywhere simultaneously but rather always only in the region under the coil 8-1, 8-2. Thermal input zones and cooling-down zones thus arise over the component 2. These zones are schematically depicted in FIG. 2 in which a heating respectively takes place in the zones I-1, I-2, while no heating takes place in the zones II-1, II-2 since the component 2 is not covered by the coils 8.

A point P (see FIG. 1) on the component thus passes under the coils 8-1, 8-2 in the zones I-1, I-2 and heated, while outside the coils 8-1, 8-2 it cools down again-no heat input takes place herein the zones I-1, I-2. If the temperature is measured at the points A and B, i.e., directly after exiting from the coverage of the first coil 8-1 (point A) and shortly before entry into the coverage region of the second coil 8-2 (point B), then a temperature difference AT arises that should be as low as possible at the end of the hardening process.

In the case of a pulse hardening, i.e., with a repeated passing over of a point P with the inductor during the hardening, the heating of the component 2, measured at a point P at the locations A and B thus follows a heating curve 20 depicted graphically in FIG. 3 in which the time t is plotted on the x-axis, and the temperature T is plotted on the y-axis.

As can be seen from the graph 20, the observed location P is strongly heated with each pass of the coil 8-1, 8-2 so that for example, during the second pass at the location A (see FIG. 2), i.e. shortly before the exit from the influence region of the coil 8-1, the temperature at location P has a maximum value T_{A1}. If the point P is moved out from the influence of the coil, the temperature decreases until shortly before entry into the (next) coil 8-2 (see location B) it has a minimum value T_{B1}. The temperature difference ΔT₁ is comparatively large.

However, despite the cooling down between the coils, as can be seen from FIG. 3, the temperature of the component increases overall, and at time t_{X} finally reaches or exceeds the predetermined temperature T_{X}. This can be, for example, the austenitization start temperature, the austenitization end temperature, or a temperature in the range between austenitization start temperature and austenitization end temperature. In the diagram of FIG. 3, the predetermined temperature T_{X} is reached at approximately half of the entire hardening time t_{final}. This reduced heat input is characterized in the curve 20 by an overall flattened temperature increase as well as a reduced temperature fluctuation range ΔT₂ between the maximum temperature T_{A2} and the minimum temperature T_{B2}.

Furthermore, FIG. 3 shows that with when a final temperature T_{final} is reached or at the end of the heating time t_{final}, the component 2 is quickly quenched as usual to a temperature below the martensite start temperature, and the inductive hardening process is thus completed.

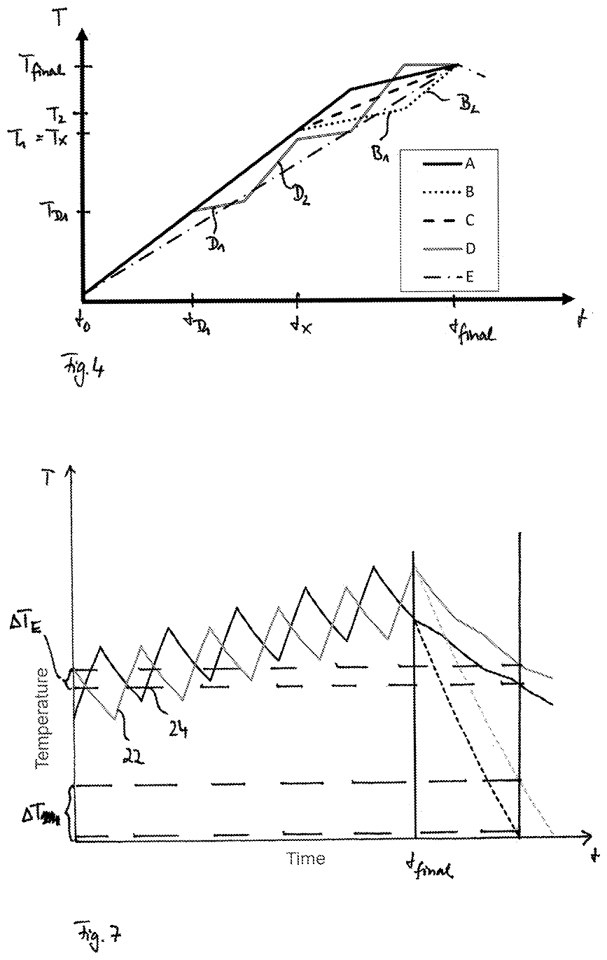

In addition to the control depicted in FIG. 3, in which starting from a certain temperature value T_{X} a reduction of the heat input occurs, other variable heat inputs are also possible. Thus, FIG. 4 shows a plurality of hardening method options that work with a variable heat input in order to reach the final temperature T_{final} at the time t_{final}, at which the heating process is completed and the component 2 is quickly cooled down to a temperature below the martensite start temperature (T_{Ms}). Here, in an analogous manner to the method discussed in FIG. 3, in which methods designated as A and C are used to reach a certain temperature T_{X} (see method C) or when reaching a certain time t_{X} (see method A), the heat output is reduced so that the temperature increase overall runs flatter. After the reaching of the time t_{final}, the heat input is stopped and a usual quenching process is initiated after the induction hardening.

Here T_{X} can again be the austenitization start temperature, the austenitization end temperature, or a temperature between the two.

In the method designated as E, a heat input reduced in comparison to the methods A-D is effected over the entire time t₀ to t_{final}, which is also further continued after the reaching of the time t_{final}, in which the heat input is reduced even further. In the method according to E, the heating process is thus extended beyond reaching the heating time t_{final}, in which the strongly reduced further heat input after the reaching of the time t_{final} ensures a further temperature harmonization of the component in the circumferential direction. Even when in this method the maximum possible heat input for the system is not used (which can be seen from the less-steeply extending curve), then for the method E itself, up to reaching the time t_{final}, the heat input is nevertheless maximized in the context of the parameters used for the method.

In addition to a section with reduced heat input B₁; D₁, the methods designated as B and D include at least one further section B₂; D₂ with maximized heat input. Thus, for example, in the method designated with B, starting from reaching the predetermined temperature T_{X}=T₁, up to reaching a second temperature T₂, a reduced heat input is provided, wherein starting from the reaching of the temperature T₂ the heat input is again maximized until the temperature T_{final} is reached at the time t_{final}.

Here T₁ can be the austenitization start temperature and T₂ the austenitization end temperature. However, T₁ or T₂ can also lie between the austenitization start temperature and the austenitization end temperature.

In the method designated with D, the heat input is preferably alternately reduced or maximized at regular intervals from the reaching of a temperature T_{D1} or a certain time t_{D1}. In the depicted exemplary embodiment, three sections with maximum heat input alternate with three sections with reduced heat input. The temperature T_{D1} can also lie below the austenitization start temperature.

However, in all presented variants, during the hardening method the component is heated far above the austenitization end temperature up to the temperature T_{final}, in order to dissolve to the greatest degree possible the alloy elements necessary for the to-be-achieved structure in the austenite.

As mentioned above, a reduction of the heat input is preferably effected during the first time reaching the austenitization start temperature (at approximately 700° C. to 1100° C., depending on the steel, microstructure state, and heating speed) in the component 2. Alternatively an adjusting can also be effected at the end of the heating time t_{final} or after reaching a desired austenitization temperature or both in combination. The reduction of the heat input can optionally also be provided only at the time at which the full quenching effect of the quenching device is achieved on the component surface, that is, up to the time at which the quenching medium is brought with full power or full flow onto the component. A further rest time is then not provided between the end of the heating (also with reduced heat input) and quenching).

The variability of the heat input can be set, as mentioned above, with the aid of the control unit 10, in which in particular a current strength, a current voltage, a current frequency, (which in particular define the heating power of the coil), a speed of the relative movement, and/or a coupling distance can be varied.

In addition to the reduction of the heating power, the coupling distance can thus also be increased for a reduction of the heat input with the heating power remaining the same, or both in combination. In addition, the relative speed between component and tool (induction coil) can be increased, which is also conducive to the temperature uniformity in the ring.

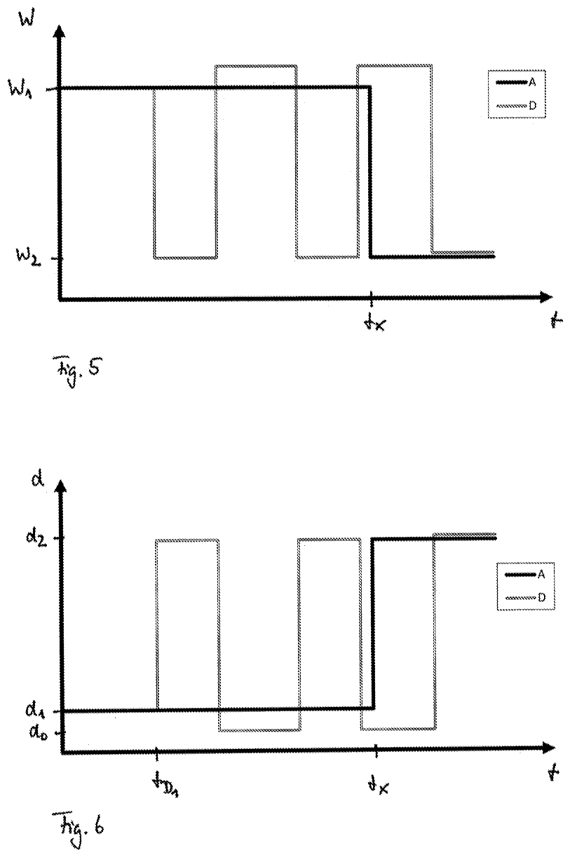

FIG. 5 and FIG. 6 illustrate such a variable heat input in which the heat input can here can be achieved, for example, via the heating power W (see FIG. 5) or the coupling distance d (see FIG. 6). Here in FIGS. 5 and 6, the situation for the method A with heat input only reduced at the end, and the method D with alternating first, and second reduced, heat input is respectively illustrated.

In FIG. 5, with regard to method A, the heat input is reduced by a first high heating power W₁ at time t_{X} to the second heating power W₂, or alternated between two heating powers W₁, W₂ (method D). As can furthermore be seen from FIG. 5, with alternating methods a third heating power W₃ higher than W₂ can also be used.

In FIG. 6, the reduced heat input is provided over a greater coupling distance d₂. As can also be seen from FIG. 6, in the comparison of the different methods A, D, different coupling distances can also be used. Thus, for example, with the alternating method D, the narrowest coupling distance d₀ is smaller than the smallest coupling distance d₁ at the start of the method or in comparison with method A.

The maximum temperature difference ΔT to be expected in the circumferential direction of the component after the inventive hardening method is reduced by the above-mentioned measures to at most 40° C., preferably no more than 30° C., most preferably no more than 20° C. This preferably applies both for the austenitization temperature range between austenitization start temperature between, e.g., 700° C.-1100° C., and the austenitization end temperature between, e.g., 750° C. and 1150° C., depending on the steel, microstructure state, and heating speed, as well as for the point in time of the quenching used.

Due to the variable heat input, undesired microstructure components are preferably reduced or largely avoided after/during the quenching (bainite, perlite, ferrite). In addition, a premature lowering of the temperature (losses due to radiation, heat conduction, convection) between the times “end heating time” and “start quenching” can be prevented by the further heating with reduced heat input, whereby undesirable microstructure components can be avoided/controlled. If active heat input does not occur during the quenching delay/temperature equalization, but rather a rest time without any heat input, a temperature homogenization specifically also occurs, but the comparatively rapid cooling down requires a higher hardening temperature overall in order to compensate for the rapid temperature drop due to convection/conduction/radiation. In contrast, if further heat is actively introduced, a higher hardening temperature and a higher hardenability can be achieved overall.

FIG. 7 shows, for the method E, a comparison of the temperature development with (solid line) and without (dashed line) active post-heating with reduced heating power after reaching the heating time t_{final}, in which the graph 22 represents the temperature development at point A, and the graph 24 represents the temperature measurement at point B. Here upon the reaching of the time t_{final}, the heat input is reduced to 10% of the first heat input.

It can be seen in FIG. 7 that starting from the time t_{final}, with the application of a reduced heat input a smoother subsiding or a smoother cooling-down of the component occurs than when at time t_{final} the power supply would be completely stopped (see dashed line contour). This additional, even if slight, heat input can lead to a particularly good temperature compensation, since the component 2 itself is not solely responsible for the heat input into the colder zones, but is supported by the additional, even if reduced, heat input of the coils. This leads to a particularly homogeneous temperature distribution and also an increased hardening depth before the induction coils are completely switched off and the quenching process begins.

This can also be read directly from FIG. 7, since at a time t_{y} after the heating time t_{final}, ΔT, i.e., the temperature difference at points A and B is much larger with complete shutdown than ΔT_{E} with active post-heating.

Furthermore, preferably at a depth of up to 50% of the nominal minimum hardening depth, the proportion of the non-martensitic components (bainite/perlite/ferrite) in the microstructure is usually at most 0.5%, preferably at most 0.4%, most preferably 0%, and at a depth of up to the nominal minimum hardening depth, the proportion of the non-martensitic components (bainite/perlite/ferrite) in the microstructure is at most 4.0%, preferably at most 3.5%, most preferably 0%.

Due to the active, although reduced, heat input after reaching the austenitization temperature, especially at depth, a more uniform microstructure transformation is achieved.

Furthermore, due to the variable heat input, an optimized residual stress distribution (in the circumferential direction and radial direction) is achieved: The additionally introduced heat, e.g., in the case of an extended heating time with reduced heat input before the quenching (see method E in FIG. 4 or FIG. 7) leads to an additional heating of the component core. In this way, during the subsequent quenching/cooling a contraction of the core leads to additional residual compressive stresses in the previously transformed, already martensitic hardened layer. The increase of the residual compressive stresses starting from a depth of 100 μm up to the lower nominal hardening depth (SHD) can preferably be at least 200 MPa, preferably 300 MPa, most preferably 400 MPa or more. However, residual compressive stresses of over 1,200 MPa should be avoided.

The improved stress distribution during the quenching due to avoiding a premature temperature loss in the near-surface regions of the component and the mechanical stresses and stress gradients associated therewith lead to a reduced risk of cracking during quenching.

As mentioned above, the temperature uniformity can also be improved over the circumference of the workpiece. This leads to a homogenization of the solution state in the microstructure, or a homogenization of the temperature associated with the solution state from which the martensite formation starts during the quenching. This in turn leads to a temporal equalization of the incipient martensite formation, whereby a stress reduction and increase in and between adjacent volumes is avoided by the accompanying change of the specific thickness/volume change.

This equalization in turn leads to a more uniform hardness distribution and consequently to a more uniform load-bearing capacity of the component overall.

The equalization of the temperature distribution and the residual stresses in the circumferential direction also lead to a reduced warpage after the hardening as well as subsequent manufacturing processes. An equalization of the temperature also leads to more uniform thermal expansions and thus to less warpage or plasticity during the heating.

In addition, the additional energy introduced prior to quenching can lead to higher temperatures inside the component, whereby a deeper hardness penetration can be set.

Overall, with the control discussed above or the method discussed above, it can be achieved that, before quenching, the component as a whole achieves a temperature distribution that is as uniform as possible in its hardness range. As a result, stresses in the component can be balanced and a particularly good and even hardness can be achieved. In addition, the hardening depth can also be increased as a result, since heat does not have to be extracted from the component from the inside to the outside to equalize the temperature before quenching.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved induction hardening methods and systems.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

2 Workpiece
4 Work table
6 Drive mechanism
8 Induction coil
10 Control unit
12 Induction coil holder
d Coupling distance
16 Generator
100 Hardening system
T Temperature
t Time
W Heating power
T_{X} Predetermined temperature
t_{X} Predetermined time
t_{final} Final heating time
T_{final} Final heating temperature

What is claimed is:

1. An inductive hardening system for hardening a component, the inductive hardening system comprising:
a holding unit for holding the component;
an induction coil configured to induce an electrical current in the component to heat the component,
a control unit configured to control the induction coil to produce a first amount of heat per unit area in the component until a predetermined temperature is reached and/or a predetermined time is elapsed, and after the predetermined temperature is reached and/or the predetermined time is elapsed, to control the induction coil to produce a second amount of heat per unit area in the component, the second amount of heat being from 3% to 80% of the first amount of heat.

2. The inductive hardening system according to claim 1,
wherein the induction coil is energizable by a generator with alternating current of predetermined magnitude, and
wherein the control unit is configured to control the generator to adjust a current strength and/or a voltage and/or a frequency of the alternating current to produce the first amount of heat per unit area and the second amount of heat per unit area.

3. The inductive hardening system according to claim 2,
including a holder configured to hold the induction coil at a coupling distance from the component,
wherein the control unit is configured to control the holder to set a first coupling distance to produce the first amount of heat per unit area and to set a second coupling distance to produce the second amount of heat per unit area, the second coupling distance being less than the first coupling distance.

4. The inductive hardening system according to claim 1,
wherein the induction coil is configured to partially cover the component,
wherein the induction coil and the component are movable relative to each other, and
wherein the control unit is configured to control a relative speed between the induction coil and the component.

5. The inductive hardening system according to claim 4,
wherein the control unit is configured to set the relative speed of the induction coil and the component to a first speed until the predetermined temperature is reached and/or the predetermined time is elapsed and to set the relative speed of the induction coil and the component to a second speed greater than the first speed after the predetermined temperature is reached and/or the predetermined time is elapsed.

6. The inductive hardening system according to claim 5,
wherein the first relative speed is selected to produce the first amount of heat per unit area, and the second relative speed is selected to produce the second amount of heat per unit area.

7. The inductive hardening system according to claim 1,
wherein the predetermined temperature is an austenitization start temperature, an austenitization end temperature, or a temperature between the austenitization start temperature and the austenitization end temperature.

8. The inductive hardening system according to claim 1,
wherein the control unit is configured to alternate during the hardening between a first heat input and a second, reduced heat input.

10. A method for inductively hardening a component, comprising:
controlling an induction coil and/or a relative movement between the induction coil and the component to produce a first amount of heat per unit area in the component until a predetermined temperature is reached and/or a predetermined time is elapsed, and
after the predetermined temperature is reached and/or the predetermined time is elapsed, controlling the induction coil and/or a relative movement between the induction coil and the component to produce a second amount of heat per unit area in the component, the second amount of heat being from 3% to 80% of the first amount of heat.

11. An inductive hardening system for hardening a component, the inductive hardening system comprising:
a holding unit for holding the component;
an induction coil configured to induce an electrical current in the component to heat the component, and
a control unit configured to control the induction coil to produce a first amount of heat per unit area in the component or a second amount of heat per unit area in the component, the second amount of heat being less than the first amount of heat, and to alternate between controlling the induction coil to produce the first amount of heat and the second amount of heat until a predetermined temperature is reached and/or a predetermined time is elapsed,
wherein the second amount of heat is from 3% to 80% of the first amount of heat.
